(19) United States
(12) Patent Application Publication
(10) Pub. No.: US 2002/0103845 A1
(43) Pub. Date: Aug. 1, 2002

(54) Method for obtaining hardware resources and apparatus for obtaining hardware resources

(76) Inventors: Masafumi Maekawa, Osaka (JP); Masaru Goto, Osaka (JP); Hisatoshi Miura, Osaka (JP); Makoto Tanaka, Osaka (JP); Yasunobu Taguchi, Osaka (JP); Jin Shibata, Osaka (JP); Yumiko Arai, Osaka (JP); Takaya Nomura, Osaka (JP)

Correspondence Address: KATTEN MUCHIN ZAVIS ROSENMAN, 575 MADISON AVENUE, NEW YORK, NY, 10022-2585, US

(21) Appl. No.: 09/923,052

(22) Filed: Aug. 6, 2001

(30) Foreign Application Priority Data
Jan. 30, 2001 (JP) 2001-22414

(51) Int. Cl. G06F 9/00

(52) U.S. Cl. 709/102; 709/225

(57) ABSTRACT

In a method for obtaining hardware resource, one of the hardware resources in the system, which resources have not been obtained, is obtained for the resource usage of a hardware resource obtaining request, when each use rate of the hardware resources, which have been obtained and which resource usages are identical with that of the hardware resource obtaining request exceeds a predetermined threshold.

### BACKGROUND OF THE INVENTION

1. Field of the Invention

The present invention generally relates to methods for obtaining hardware resources and apparatuses for obtaining hardware resources, and more particularly to a method for obtaining hardware resources and an apparatus for obtaining hardware resources that can dynamically assign shared hardware resources.

2. Description of the Related Art

FIG. 1 is a block diagram showing a construction of a switching system. In FIG. 1, member trunk cards 14₁ through 14ₙ and 15₁ through 15ₙ are provided as hardware resources in member interface apparatuses 10 and 12 and user equipment such as cellular phone 16, a data terminal 18, a facsimile 20 and the like are connected to the member trunk cards 14₁ through 14ₙ and 15₁ through 15ₙ. A service type is defined as a resource usage for each of the member trunk cards 14₁ through 14ₙ and 15₁ through 15ₙ and user equipment corresponding to the service type is connectable to one of ports of the member trunk cards. The member interface apparatuses 10 and 12 are connected to a core switch 22 and also the core switch 22 is connected to the other switching device. The core switch 22 conducts switching lines. A processor 24 is connected to the member interface apparatuses 10 and 12 and the core switch 22. Also the processor 24 controls the member trunk cards 14₁ through 14ₙ and 15₁ through 15ₙ in the member interface apparatuses 10 and 12, respectively, and controls switching the core switch 22.

Conventionally, when the member trunk cards 14₁ through 14ₙ and 15₁ through 15ₙ are mounted in the switching system, the service type is defined to each of the member trunk cards 14₁ through 14ₙ and 15₁ through 15ₙ by the processor 24. When a connection request is received from the user equipment (user terminal), one member trunk card which service type corresponds to the service type requested is assigned to the user equipment.

In an assigning method of the conventional switching system, it is required to accurately estimate a required amount of each service type. However, in a case in which the required amount of each service type is overestimated, an unfavorable state is occurred in which there is no empty capacity for the member trunk card having the service type requested by the user equipment, even if there are empty capacities for other member trunk cards having another service type. In this state, the member trunk card can not be assigned for the user equipment which sent the connection request.

### SUMMARY OF THE INVENTION

It is a general object of the present invention to provide a method for obtaining hardware resources and an apparatus for obtaining hardware resources in which the above-mentioned problems are eliminated.

A more specific object of the present invention is to provide the method for obtaining hardware resources and the apparatus for obtaining hardware resources in which a minimum hardware resource amount can be secured for each resource usage provided by a switching system and it is possible to effectively assign hardware resources by assigning a larger amount of a hardware resource for a resource usage requiring a larger demand.

The above objects of the present invention are achieved by a method for obtaining hardware resource, the method including the steps of: obtaining one of the hardware resources in a system, which resources have not been obtained, for a resource usage of a hardware resource obtaining request, when each use rate of the hardware resources, which have been obtained and which resource usages are identical with that of the hardware resource obtaining request, exceeds a predetermined threshold, whereby one of hardware resources in the system is obtained based on the resource usage indicated by the hardware resource obtaining request every time the hardware resource obtaining request occurs.

The resource usage assigned to each member trunk card is changed based on a state of the hardware resource obtaining request from a user. According to the present invention, it is possible to assign more hardware resources for a larger demanded resource usage. Therefore, the hardware resources can be effectively assigned and also a transaction stress can be distributed to many member trunk cards so as to reduce the number of user terminal that may be damaged when an error occurs to a certain member trunk card.

The above objects of the present invention are achieved by an apparatus for obtaining hardware resource, the apparatus including: a first selecting-to-use part selecting one hardware resource having a least use rate in hardware resources that have been obtained in a condition in which each resource usage of the hardware resources is identical with the resource usage of a hardware resource obtaining request; and a using part using a part of an unused area of the one hardware resource selected by the first selecting-to-use part, whereby one of hardware resources in the system is obtained based on the resource usage indicated by the hardware resource obtaining request every time the hardware resource obtaining request occurs.

According to the present invention, it is possible to average the use rates of the member trunk cards having the same resource usage so as to distribute the transaction stress to the member trunk cards.

The above objects of the present invention are achieved by an apparatus for obtaining hardware resource, the apparatus including: a second selecting-to-use part selecting one hardware resource which has the use rate being less than a upper limit and has a largest resource, in hardware resources that have been obtained in a condition in which each resource usage of the hardware resources is identical with the resource usage of a hardware resource obtaining request; and a using part using a part of an unused area of the one hardware resource selected by the second selecting-to-use part, whereby one of hardware resources in the system is obtained based on the resource usage indicated by the hardware resource obtaining request every time the hardware resource obtaining request occurs.

According to the present invention, it is possible to remain more unused member trunk cards. Therefore, in a case in which a specific resource usage is intensively required, the hardware resource request indicating the specific resource usage can be acceptable.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a construction of a switching system;

FIG. 2 is a block diagram explaining a function in a basic principle of the present invention;

FIG. 3 is a flowchart for explaining a hardware resource obtaining process executed by the resource management module according to a first embodiment of the present invention;

FIG. 4 is a flowchart for explaining an accumulating process executed by the resource management module according to the first embodiment of the present invention;

FIG. 5 is a diagram showing accumulated data 34 created by the accumulating process according to the first embodiment of the present invention;

FIG. 6 is a flowchart for explaining another hardware resource obtaining process executed the resource management module according to a second embodiment of the present invention; and

FIG. 7 is a flowchart for explaining other hardware resource obtaining process according to a third embodiment of the present invention.

### DESCRIPTION OF THE PREFERRED EMBODIMENTS

[Basic Principle]

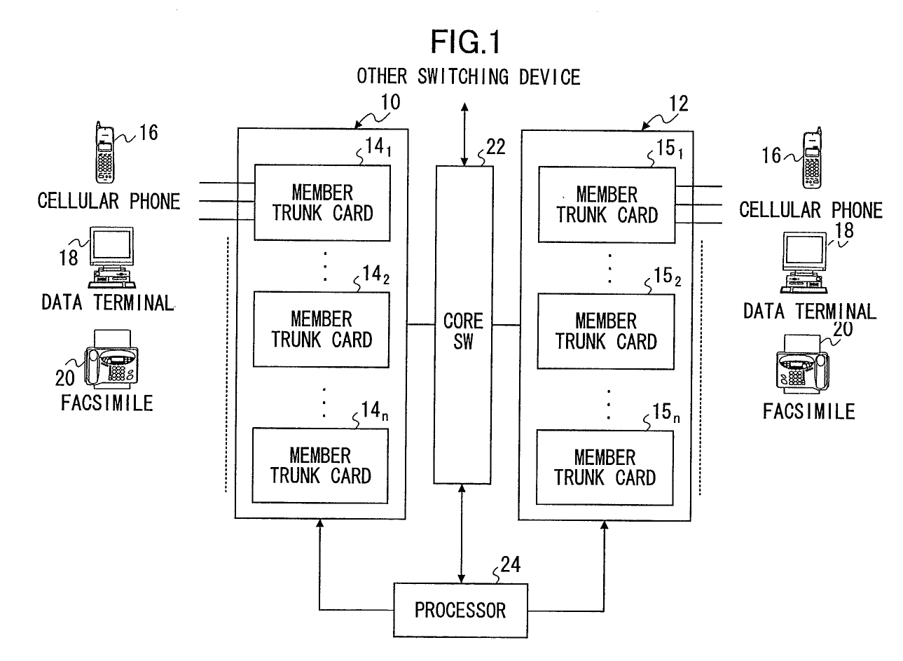

The present invention can be realized by a resource management module executed by the processor 24 in FIG. 1.

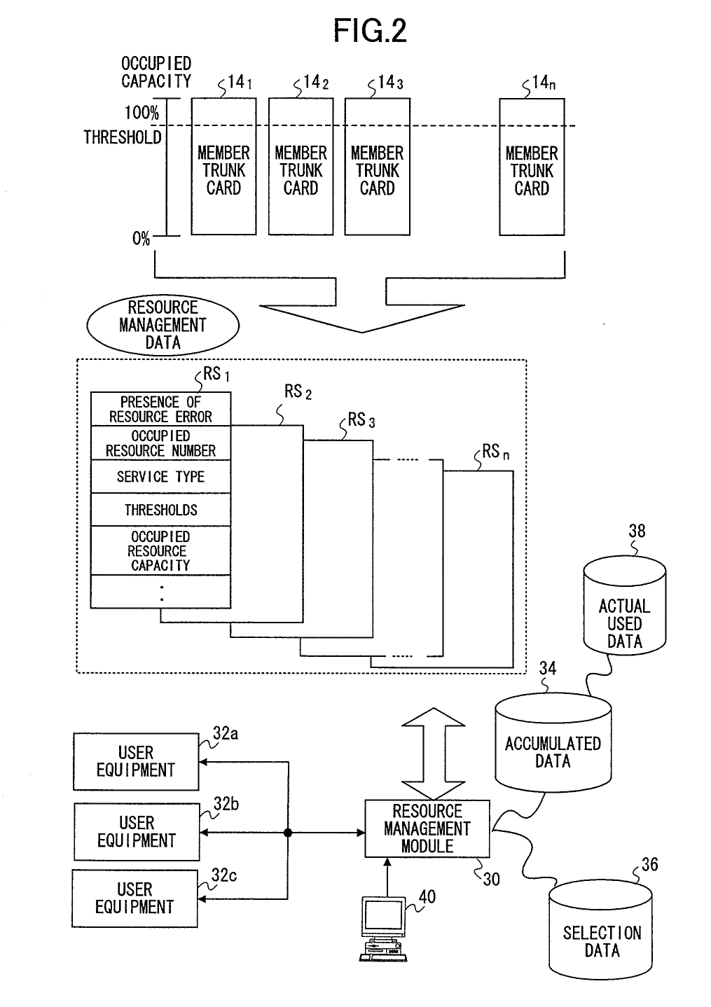

FIG. 2 is a block diagram explaining a function in a basic principle of the present invention. In FIG. 2, a resource management module 30 stores resource management data RS₁ through RSₙ corresponding to the member trunk cards 14₁ through 14ₙ (for example, n can be 800 at maximum) in the member interface apparatus 10, respectively, in a memory provided in the processor 24. Also, the resource management module 30 stores resource management data corresponding to the member trunk cards 15₁ through 15ₙ in the member interface apparatus 12, respectively. However, for the sake of convenience, the member trunk cards 15₁ through 15ₙ are not shown in FIG. 2.

Each of the resource management data RS₁ through RSₙ includes a presence of a resource error related to a relative member trunk card, an occupied resource number showing an occupied port number of the relative member trunk card, a service type of the relative member trunk card, thresholds, an occupied resource capacity showing a used transmission band.

In general, for example, 1024 ports for each of the member trunk cards 14₁ through 14ₙ are available (a number of usable resources is 1024 at maximum) and a transmission band is for example 64 Kbps at maximum. The thresholds are defined for each of the occupied resource number and the occupied resource capacity and a default value of the threshold is 70%.

Three service types are used as the resource usage: BE (Best Effort) that is used for a TV phone or the like and does not guarantee to data errors, PBE (Premium Best Effort) that is used for the TV phone or the like and guarantees to data error at minimum, CBR (Constant Bit Rate) that is used to download sound data or the like and guarantees to data errors. When any one of the three service types is not defined to the member trunk card, it is shown that the member trunk card is not used. On the other hand, when any one of the three service types is defined to the member trunk card, it shows that the member trunk card is used. It is possible to set any one of the three service types to each member trunk card. However, once the service type is defined to the member trunk card, it can not be allowed to use the member trunk card for other service types.

When the user equipment 32a, 32b or 32c of each user conducts a resource obtaining request associating with a connection request, the resource management module 30 obtains a proper hardware resource, that is, the member trunk card by using the resource management data RS₁ through RSₙ and accumulated data 34 stored in a memory of the processor 24 or selection data 36.

The resource management module 30 stores an actual use for each service type as actual used data in the memory of the processor 24, creates the accumulated data 34 based on the actual used data 38, and determines the threshold for each of the resource management data SR₁ through SRₙ based on the accumulated data 34. The selection data 36 is set by a manager of the switching system from a work station 40.

[First Embodiment]

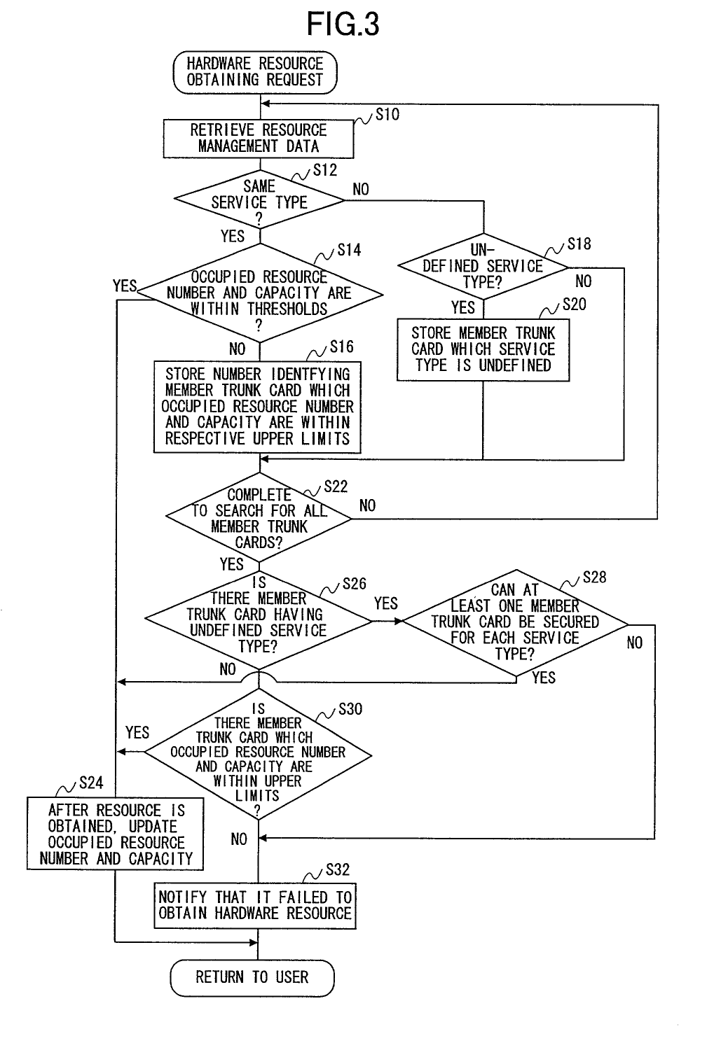

FIG. 3 is a flowchart for explaining a hardware resource obtaining process executed by the resource management module according to a first embodiment of the present invention. The hardware resource obtaining process is activated when a hardware resource obtaining request is received from the user terminal. In the hardware resource obtaining request, the service type and a required transmission band are indicated.

Steps S10 through S22 are repeated for the member trunk cards 14₁ through 14ₙ that are hardware resources mounted in the member interface apparatus 10. In the step S10, the resource management data RSₘ (m=1, 2, . . . , n) is retrieved. In step S12, it is determined based on the resource management data RSₘ whether or not the service type indicated by the hardware resource obtaining request corresponds to the service type defined for the member trunk card 14ₘ (m=1, 2, . . . , n). The resource management data RSₘ corresponding to the member trunk card 14ₘ is sequentially retrieved in the step S10.

When it is determined that the service type indicated by the hardware resource obtaining request corresponds to the service type defined for the member trunk card 14ₘ, the hardware resource obtaining process advances to step S14. In the step S14, it is determined whether or not the occupied resource number and the occupied resource capacity indicated by resource management data RSₘ for the member trunk card 14ₘ is within the thresholds (less than the thresholds), respectively. When it is determined that the occupied resource number and the occupied resource capacity is within the thresholds, a port and a transmission band of the member trunk card 14ₘ are obtained, and the occupied resource number (occupied port number) and the occupied resource capacity (occupied transmission band) in the resource management data RSₘ for the member trunk card 14ₘ are updated by requested number and capacity. Then, the hardware resource obtaining process is terminated.

On the other hand, when it is determined in the step S14 that the occupied resource number or the occupied resource capacity is not within the thresholds, in step S16, a number identifying the member trunk card 14ₘ is stored under a condition in which the occupied resource number and the occupied resource capacity of the resource management data RSₘ are within upper limits, respectively. It should be noted that the upper limits is obtained by subtracting the requested number and capacity from maximum number and capacity, respectively. The hardware resource obtaining process advances to step S22. In the step S22, it is completed to search for all member trunk cards 14₁ through 14ₙ. When it is determined that it is not completed to search for all member trunk cards 14₁ through 14ₙ, the hardware resource obtaining process is repeated from the step S10.

On the other hand, when it is determined in the step S12 that the service type indicated by the hardware resource obtaining request does not correspond to the service type of the member trunk card 14ₘ, the hardware resource obtaining process advances to step S18. In the step S18, it is determined whether or not the service type of the member trunk card 14ₘ is not defined. The number identifying the member trunk card 14ₘ is stored under a condition in which the service type of the member trunk card 14ₘ is not defined and then the step S22 is executed to determine whether or not it is completed to search for all member trunk cards 14₁ through 14ₙ. Then, when it is determined that the hardware resource obtaining process does not complete to search for all member trunk cards 14₁ through 14ₙ, the hardware resource obtaining process goes back to the step S10 to repeat the above steps.

When it is determined in the step S22 that the hardware resource obtaining process completes to search for all member trunk cards 14₁ through 14ₙ, the hardware resource obtaining process advances to step S26. In the step S26, it is determined whether or not there is the member trunk card which service type is not defined (that is, the number identifying the member trunk card is stored). When it is determined that the number identifying the member trunk card, which service type is not defined, is stored, the hardware resource obtaining process advances to step S28. In the step S28, it is determined whether or not it is possible to assign at least one member trunk card 14₁, 14₂, . . . , or 14ₙ for each service type (BE, PBE or CBR). When it is determined that it is possible to assign at least one member trunk card 14₁, 14₂, . . . , or 14ₙ, the hardware resource obtaining process advances to step S24. In the step S24, the service type indicated by the hardware resource obtaining request is set to the member trunk card which service type is not defined so as to obtain a resource, a port and a transmission band for the member trunk card 14ₘ. And the occupied resource number (occupied port number) and occupied resource capacity (used transmission band) of the resource management data RSₘ for the member trunk card 14ₘ are updated by the requested number and capacity. Then, the hardware resource obtaining process is terminated.

On the other hand, when it is determined in the step S28 that it is not possible to assign at least one member trunk card 14₁, 14₂, . . . , or 14ₙ for each service type, the hardware resource obtaining process advances to step S32. In the step S32, the hardware resource obtaining process notifies the user that it failed to obtain a hardware resource and then is terminated.

Also, when it is determined in the step S26 that there is no the member trunk card which service type is not defined, the hardware resource obtaining process advances to step S30. In the step S30, it is determined whether or not there is the member trunk card 14ₘ in that the occupied resource number and the occupied resource capacity of the resource management data RSₘ for the member trunk card 14ₘ are within upper limits, respectively (that is, whether or not the number identifying the member trunk card 14ₘ is stored). When it is determined that the number identifying the member trunk card 14ₘ is stored, the hardware resource obtaining process advances to the step S24. In the step S24, the port and the transmission band are obtained for the member trunk card 14ₘ. The occupied resource number (occupied port number) and the occupied resource capacity (occupied transmission band) in the resource management data RSₘ for the member trunk card 14ₘ are updated by requested number and capacity. Then, the hardware resource obtaining process is terminated.

On the other hand, it is determined in the step S30 that there is no the member trunk card 14ₘ in that the occupied resource number and the occupied resource capacity of the resource management data RSₘ for the member trunk card 14ₘ are within upper limits, the hardware resource obtaining process advances to the step S32 in order to notify the user that it failed to obtain a hardware resource and then is terminated.

As described above, since the service type (resource usage) assigned to each member trunk card 14ₘ can be changed based on a state of the hardware resource obtaining request sent from the user, it is possible to assign more hardware resources for more demanded the service type. That is, it is possible to effectively assign the hardware resources. In addition, when the occupied resource number or the occupied resource capacity for each member trunk card exceeds the thresholds, another member trunk card can be assigned for a requested service type. Therefore, a transaction process can be distributed to a plurality of the member trunk cards 14₁ through 14ₙ. Consequently, when an error occurs in one of the member trunk cards 14₁ through 14ₙ, it is possible to reduce the number of the user terminals affected by the error.

Moreover, since at least one member trunk card 14₁, 14₂, . . . , or 14ₙ as hardware resource can be secured for each of a plurality of the service types, it is possible to secure minimum hardware resources for all service types provided by the switching system.

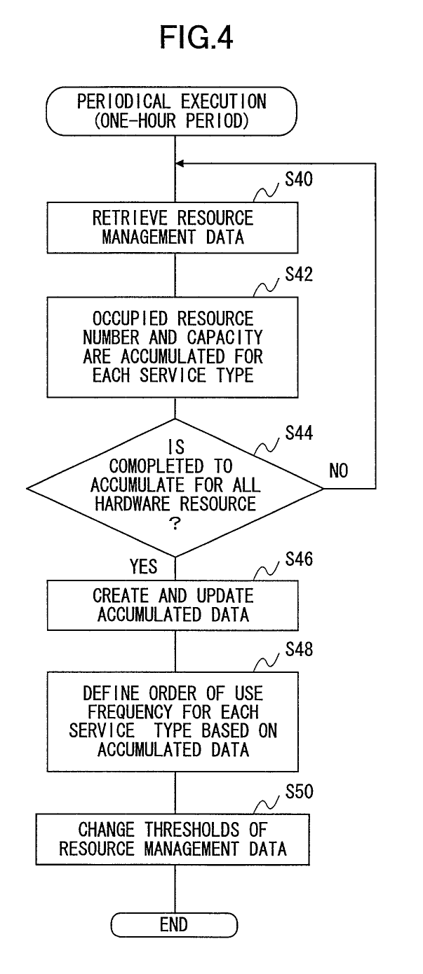

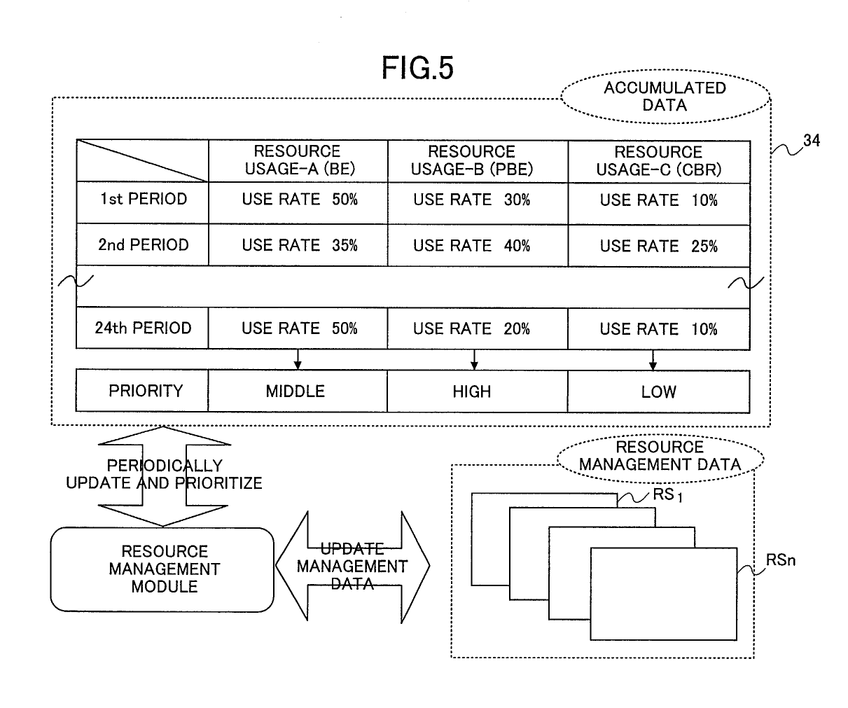

FIG. 4 is a flowchart for explaining an accumulating process executed by the resource management module according to the first embodiment of the present invention. The accumulating process is an interrupt process executed at a predetermined time period, for example, such as one-hour period. FIG. 5 is a diagram showing accumulated data 34 created by the accumulating process according to the first embodiment of the present invention.

Steps S40 through S44 are repeated for the member trunk cards 14₁ through 14ₙ that are hardware resources mounted in the member interface apparatus 10. In the step S40, the resource management data RSₘ (m=1, 2, . . . , n) is retrieved. In the step S42, the occupied resource number (occupied port number) and the occupied resource capacity (used transmission band) are obtained from the resource management data RSₘ and add to previously retrieved the occupied resource number and the occupied resource capacity, respectively, for each service type. The resource management data RSₘ corresponding to the member trunk card 14ₘ is sequentially retrieved in the step S10. Subsequently, in the step S44, it is determined whether or not it is completed to accumulate the occupied resource number and the occupied resource capacity, respectively, for each service type of all member trunk cards 14₁ through 14ₙ. When it is determined that it is not completed, the accumulating process goes back to the step S40.

When it is determined in the step S44 that it is completed, the accumulating process advances to step S46. In the step S46, the accumulating process calculates a use rate of each of the occupied resource number (occupied port number) and the occupied resource capacity (used transmission band) for each service type, and stores the use rate each of the occupied resource number and the occupied resource capacity as accumulated data 34 by corresponding to a current process period. Thus, one record of the accumulated data 34 shown in FIG. 5 is created. In FIG. 5, it should be noted that a resource usage A indicates the service type BE, a resource usage B indicates the service type PBE, and a resource usage C indicates the service type CBR.

In step S48, the accumulating process prioritizes the service types in an order of descending the use rate for the accumulated data 34 of a next process period to define high, middle and low priorities to the service types. In the accumulated data 34 shown in FIG. 5, it is assumed that the current process period is a first period. Thus, the next process period is a second period. And the service type BE has the middle priority, the service type PBE has the high priority, and the service type CBR is the low priority.

After that, in step S50, for example, the accumulating process sets 50% as the use rate to the threshold of the service type for each of the member trunk cards which service type has the high priority, 70% the use rate to the threshold of the service type for each of the member trunk cards which service type has the high priority, and 90% the use rate to the threshold of the service type of each member trunk cards which service type has the high priority, in the resource management data RS₁ through RSₙ for the member trunk cards 14₁ through 14ₙ. And then the accumulating process is terminated.

As described above, by setting a lower threshold for the member trunk cards having the service type indicating higher priority, even if the occupied resource number and the occupied resource capacity of the member trunk cards, which have the service type showing a greater use rate, show a low number and a low capacity, another member trunk card is assigned. Therefore, more member trunk cards are secured for the service type having a higher priority.

In the first embodiment, the accumulated data 34 is updated every one hour for one day and then the thresholds for the member trunk cards 14₁ through 14ₙ are determined based on the priority of each service type. In addition, the accumulated data 34 for one day can be averaged every day and then the thresholds for the member trunk cards 14₁ through 14ₙ are determined. Also, the thresholds of the resource management data RS₁ through RSₙ can be set by a manager of the switching system through the workstation 40 shown in FIG. 2.

[Second Embodiment]

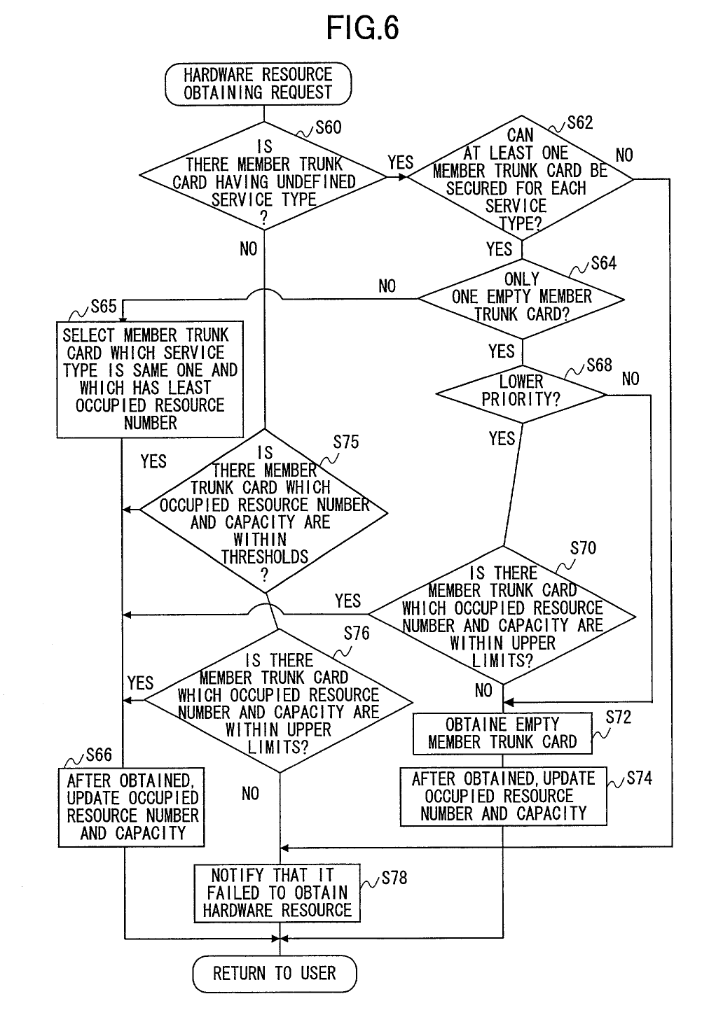

FIG. 6 is a flowchart for explaining another hardware resource obtaining process executed the resource management module according to a second embodiment of the present invention. In this hardware resource obtaining process, it is a precondition in that the accumulating process is executed and then the priority is determined. When a hardware resource obtaining request is received from the user terminal, the hardware resource obtaining process is activated. In the hardware resource obtaining request, the service type and a required transmission band are indicated.

In step S60, it is determined from the resource management data RS₁ through RSₙ whether or not there are some of the member trunk cards 14₁ through 14ₙ, which service types are not defined. When it is determined that there are some of the member trunk cards 14₁ through 14ₙ, which service types are not defined, the hardware resource obtaining process advances to step S62. In the step S62, it is determined whether or not it is possible to assign at least one member trunk card 14₁, 14₂, . . . , or 14ₙ for each service type (BE, PBE or CBR). When it is determined that it is possible, the hardware resource obtaining process advances to step S64. In the step S64, it is determined based on the resource management data RS₁ through RSₙ whether or not there is only one member trunk card 14_{q} (q=1, 2, . . . , n) which service type is not defined.

When it is determined in the step S64 that there are more than two of the member trunk cards 14₁ through 14ₙ, which service types are not defined, the hardware resource obtaining process advances to step S65. In the step S65, the hardware resource obtaining process searches for the member trunk cards 14₁ through 14ₙ, which service types show the same service type indicated by the hardware resource obtaining request, and selects one of the member trunk cards 14₁ through 14ₙ, in which the occupied resource number or the occupied resource capacity is the least number or the least capacity, based on a search result. Subsequently, in step S66, a port and transmission band of a selected the member trunk card 14ₚ (p=1, 2, . . . , n) are obtained and then the occupied resource number (the port number) and the occupied resource capacity (used transmission band) of the resource management data RSₚ corresponding to the member trunk card 14ₚ are updated by requested number and capacity. Then, the hardware resource obtaining process is terminated.

On the other hand, when it is determined in the step S64 that there is only one member trunk card 14_{q} which service type is not defined, the hardware resource obtaining process advances to step S68. In the step S68, it is determined whether or not the service type of the hardware resource obtaining request is set as a lower priority in the accumulated data 34. When it is determined that the service type of the hardware resource obtaining request is set as a lower priority, the hardware resource obtaining process advances to step S70. In the step S70, it is determined whether or not the occupied resource number and the occupied resource capacity are within the upper limits, respectively, based on each of the resource management data RS₁ through RSₙ in a condition in which the service types defined in the member trunk cards 14₁ through 14ₙ are the same service type of the hardware resource obtaining request. When it is determined that the occupied resource number and the occupied resource capacity of the resource management data RSᵣ (r=1, 2, . . . , n) are within the upper limits, the hardware resource obtaining process advances to step S66 in order to update the occupied resource number (the port number) and the occupied resource capacity (used transmission band) of the resource management data RSᵣ corresponding to the member trunk card 14ᵣ by the requested number and capacity. Then, the hardware resource obtaining process is terminated.

On the other hand, it is determined in the step S70 that either one of the occupied resource number and the occupied resource capacity exceeds the upper limits, respectively, and it is determined in the step S68 that the priority of the service type indicated by the hardware resource obtaining request is set as the high priority or the middle priority, the hardware resource obtaining process advances to step S72. In the step S72, the service type indicated by the hardware resource obtaining request is set to the resource management data RS_{q} of the only one member trunk card 14_{q} which service type is not defined. Subsequently, in step S74, a port and transmission band of the member trunk cards 14_{q} are obtained and then the occupied resource number (the port number) and the occupied resource capacity (used transmission band) of the resource management data RS_{q} corresponding to the member trunk card 14_{q} are updated by the requested number and capacity. Then, the hardware resource obtaining process is terminated.

On the other hand, when it is determined in the step S62 that it is not possible to assign at least one member trunk card 14₁, 14₂, . . . , or 14ₙ for each service type (BE, PBE or CBR), the hardware resource obtaining process advances to step S78. In the step S78, the hardware resource obtaining process notifies the user that it failed to obtain a hardware resource and then is terminated.

Also, when it is determined in the step S60 that there are no any of the member trunk cards 14₁ through 14ₙ which service types are not defined, the hardware resource obtaining process advances to step S75. In the step S75, it is determined whether or not there is the member trunk card 14ᵣ in that the occupied resource number and the occupied resource capacity of the resource management data RSᵣ is within the thresholds, respectively. When it is determined that there is the member trunk card 14ᵣ, the hardware resource obtaining process advances to step S66 in order to update the occupied resource number (the port number) and the occupied resource capacity (used transmission band) of the resource management data RSᵣ corresponding to the member trunk card 14ᵣ by the requested number and capacity. Then, the hardware resource obtaining process is terminated.

On the other hand, when it is determined in the step S75 that there is no member trunk card 14ᵣ, the hardware resource obtaining process advances to step S76. In the step S76, it is determined whether or not there is the member trunk card 14ₚ (p=1, 2, . . . , n) in that the occupied resource number and the occupied resource capacity of the resource management data RSₚ (p=1, 2, . . . , n) corresponding to the member trunk card 14ₚ are within the upper limits, respectively. When it is determined that there is the member trunk care 14ₚ, the hardware resource obtaining process advances to S66 in order to obtain a port and transmission band of a selected the member trunk card 14ₚ and then to update the occupied resource number (the port number) and the occupied resource capacity (used transmission band) of the resource management data RSₚ corresponding to the member trunk card 14ₚ by requested number and capacity. Then, the hardware resource obtaining process is terminated.

On the other hand, when it is determined in the step S76 that there is not the member trunk card 14ₚ (p=1, 2, . . . , n) in that the occupied resource number and the occupied resource capacity of the resource management data RSₚ (p=1, 2, . . . , n) corresponding to the member trunk card 14ₚ are within the upper limits, respectively, the hardware resource obtaining process advances to step S78. In the step S78, the hardware resource obtaining process notifies the user that it failed to obtain hardware resource. Then, the hardware resource obtaining process is terminated.

As described above, when only one empty, that is, only one member trunk card 14_{q} (q=1, 2, . . . , n) which service type is not defined is remained, instead of assigning the member trunk cards 14_{q} for the service type having a lower priority, the member trunk cards 14_{q} is assigned for the service type having a higher priority. That is, the member trunk cards 14_{q} can be assigned for the service type having a greater use rate. Therefore, the greater use rate the service type has, the more the hardware resources are assigned.

[Third Embodiment]

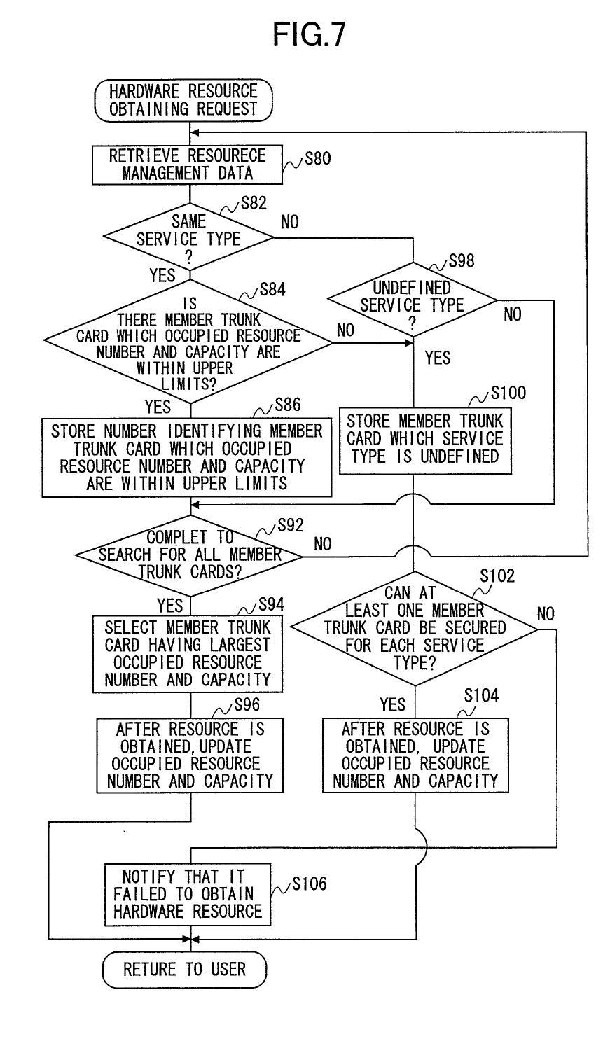

FIG. 7 is a flowchart for explaining other hardware resource obtaining process according to a third embodiment of the present invention. When a hardware resource obtaining request is received from the user terminal, the hardware resource obtaining process is activated. In the hardware resource obtaining request, the service type and a required transmission band are indicated.

Steps S80 through S92 are repeated for the member trunk cards 14₁ through 14ₙ that are hardware resources mounted in the member interface apparatus 10. In the step S80, the resource management data RSₘ (m=1, 2, . . . , n) is retrieved. In step S82, it is determined based on the resource management data RSₘ whether or not the service type indicated by the hardware resource obtaining request corresponds to the service type defined for the member trunk card 14ₘ (m=1, 2, . . . , n). The resource management data RSₘ corresponding to the member trunk card 14ₘ is sequentially retrieved in the step S80.

When it is determined that the service type indicated by the hardware resource obtaining request corresponds to the service type defined for the member trunk card 14ₘ, the hardware resource obtaining process advances to step S14. In the step S14, it is determined whether or not the occupied resource number and the occupied resource capacity indicated by resource management data RSₘ for the member trunk card 14ₘ are within the upper limits, respectively. It should be noted that the upper limits is obtained by subtracting the requested number and capacity from a maximum number and a maximum capacity, respectively. When it is determined that the occupied resource number and the occupied resource capacity are within the upper limits, respectively, the hardware resource obtaining process advances to step S86. In the step S86, a number identifying the member trunk card 14ₘ is stored under a condition in which the occupied resource number and the occupied resource capacity of the resource management data RSₘ are within upper limits, respectively.

Subsequently, in step S92, it is determined whether or not it is completed to search for all member trunk cards 14₁ through 14ₙ. When it is determined that it is not completed to search for all member trunk cards 14₁ through 14ₙ, the hardware resource obtaining process goes back to the step S80 to repeat the steps described above. When it is determined that it is completed to search for all member trunk cards 14₁ through 14ₙ, the hardware resource obtaining process advances to step S94. In the step S94, the hardware resource obtaining process searches for the member trunk cards 14₁ through 14ₙ, which service types show the same service type indicated by the hardware resource obtaining request, and selects one of the member trunk cards 14₁ through 14ₙ, in which the occupied resource number or the occupied resource capacity is the greatest number or the largest capacity, based on a search result. Subsequently, in step S96, a port and transmission band of a selected the member trunk card 14ₚ (p=1, 2, . . . , n) are obtained and then the occupied resource number (the port number) and the occupied resource capacity (used transmission band) of the resource management data RSₚ corresponding to the member trunk card 14ₚ are updated by requested number and capacity. Then, the hardware resource obtaining process is terminated.

On the other hand, when it is determined in the step S84 that either one of the occupied resource number and the occupied resource capacity is not within the thresholds, the hardware resource obtaining process advances to step S100. Also, when it is determined in the step S82 that the service type indicated by the hardware resource obtaining request does not correspond to the service type defined for the member trunk card 14ₘ, the hardware resource obtaining process advances to step S98 so as to determine whether or not the service type of the member trunk card 14ₘ is defined. When it is determined in the step S98 that the service type of the member trunk card 14ₘ is not defined, the hardware resource obtaining process advances the step S100. In the step S100, a number identifying the member trunk card 14ₘ is stored. On the other hand, it is determined in the step S98 that the service type of the member trunk card 14ₘ is defined, the hardware resource obtaining process advances to step S92. In the step S92, it is determined whether or not it is completed to search for all member trunk cards 14₁ through 14ₙ. When it is determined that it is not completed to search for all member trunk cards 14₁ through 14ₙ, the hardware resource obtaining process goes back to the step S80 to repeat the steps described above.

After the step S100 is executed, the hardware resource obtaining process advances to step S102. In the step S102, it is determined whether or not it is possible to assign at least one member trunk card 14₁, 14₂, . . . , or 14ₙ for each service type (BE, PBE or CBR). When it is determined that it is possible to assign at least one member trunk card 14₁, 14₂, . . . , or 14ₙ, the hardware resource obtaining process advances to step S104. In the step S104, the service type indicated by the hardware resource obtaining request is set to the member trunk card which service type is not defined so as to obtain a resource, a port and a transmission band for the member trunk card 14ₘ. And the occupied resource number (occupied port number) and occupied resource capacity (used transmission band) of the resource management data RSₘ for the member trunk card 14ₘ are updated by the requested number and capacity. Then, the hardware resource obtaining process is terminated.

On the other hand, when it is determined in the step S102 that that it is not possible to assign at least one member trunk card 14₁, 14₂, . . . , or 14ₙ for each service type, the hardware resource obtaining process advances to step S106. In the step S106, the hardware resource obtaining process notifies the user that it failed to obtain a hardware resource and then is terminated.

According to the third embodiment, the member trunk card 14ₘ which service type is defined is used until the occupied resource number and the occupied resource capacity achieve the upper limits, respectively. Consequently, it is possible to save more member trunk cards 14₁ through 14ₙ not to be occupied. For example, in special days around from the end of year to a new year, even when a large number of the hardware resource obtaining requests require only service type CBR other than service types BD and PBE, it is possible to effectively obtain the hardware resources in response to the hardware resource obtaining requests. The manger of the switching system inputs a schedule from the workstation 40 in FIG. 2 such that the hardware resource obtaining process in FIG. 3 is generally executed and another hardware resource obtaining process in FIG. 7 is specially executed such special days around from the end of year to a new year. The schedule input by the manager is stored as the selection data 36.

In the first, the second and the third embodiments, the step S14 corresponds to a comparing part in claims, the step S24 corresponds to an obtaining part in claims, the step S28 corresponds to a hardware resource ensuring part in claims, the steps S16 and S24 correspond to an obtaining-to-use part in claims, the steps S40 through S50 correspond to a threshold setting part, the workstation 40 corresponds to a given threshold setting part, the step S65 corresponds to a first selecting-to-use part, the step S48 corresponds to a priority setting part, the step S68 corresponds to a prohibiting part in claims, and the steps S86 and S96 correspond to a second selecting-to-use part in claims.

The present invention is not limited to the specifically disclosed embodiments, variations and modifications, and other variations and modifications may be made without departing from the scope of the present invention.

The present application is based on Japanese Priority Application No. 2001-022414 filed on Jan. 30, 2001, the entire contents of which are hereby incorporated by reference.

What is claimed is:

1. A method for obtaining hardware resource, said method comprising the steps of:
obtaining one of the hardware resources in a system, which resources have not been obtained, for a resource usage of a hardware resource obtaining request, when each use rate of the hardware resources, which have been obtained and which resource usages are identical with that of the hardware resource obtaining request, exceeds a predetermined threshold,
whereby one of hardware resources in the system is obtained based on the resource usage indicated by the hardware resource obtaining request every time the hardware resource obtaining request occurs.

2. An apparatus for obtaining hardware resource, said apparatus comprising:
a comparing part comparing a predetermined threshold with each use rate of hardware resources, which have been obtained and which resource usages are identical with that of a hardware resource obtaining request; and
an obtaining part obtaining one of the hardware resources, which resources have not been obtained, for the resource usage of the hardware resource obtaining request, when each use rate of the hardware resources being obtained exceeds the predetermined threshold,
whereby one of hardware resources in the system is obtained based on the resource usage indicated by the hardware resource obtaining request every time the hardware resource obtaining request occurs.

3. The apparatus as claimed in claim 2, further comprising:
a securing part securing some of the hardware resources so as to obtain at least one of the hardware resources for each of a plurality of resource usages.

4. The apparatus as claimed in claim 2, further comprising:
an obtaining-to-use part obtaining a part of an unused area of the hardware resources that have been obtained in a condition in which each resource usage of the hardware resources is identical with that of said hardware resource obtaining request and each use rate of the hardware resources exceeds the predetermined threshold.

5. The apparatus as claimed in claim 2, further comprising:
a threshold setting part dynamically setting a threshold of said each resource usage based on the use rate of said each resource usage of the hardware resources in the system.

6. The apparatus as claimed in claim 2, further comprising:
a given threshold setting part setting a given threshold to the threshold of said each resource usage of the hardware resources in the system.

7. An apparatus for obtaining hardware resource, said apparatus comprising:
a first selecting-to-use part selecting one hardware resource having a least use rate in hardware resources that have been obtained in a condition in which each resource usage of the hardware resources is identical with the resource usage of a hardware resource obtaining request; and
a using part using a part of an unused area of said one hardware resource selected by said first selecting-to-use part,
whereby one of hardware resources in the system is obtained based on the resource usage indicated by the hardware resource obtaining request every time the hardware resource obtaining request occurs.

8. The apparatus as claimed in claim 7, further comprising:
a threshold setting part dynamically setting a threshold of said each resource usage based on the use rate of said each resource usage of the hardware resources in the system.

9. The apparatus as claimed in claim 8, further comprising:
a priority setting part setting a priority of each resource usage based on the use rate of said each resource usage of each of the hardware resources in the system.

10. An apparatus for obtaining hardware resource, said apparatus comprising:
a second selecting-to-use part selecting one hardware resource which has the use rate being less than a upper limit and has a largest resource, in hardware resources that have been obtained in a condition in which each resource usage of the hardware resources is identical with the resource usage of a hardware resource obtaining request; and
a using part using a part of an unused area of said one hardware resource selected by said second selecting-to-use part,
whereby one of hardware resources in the system is obtained based on the resource usage indicated by the hardware resource obtaining request every time the hardware resource obtaining request occurs.
